(19) United States
(12) Patent Application Publication
(10) Pub. No.: US 2016/0119104 A1
(43) Pub. Date: Apr. 28, 2016

(54) METHOD AND APPARATUS FOR WIRELESS COMMUNICATION

(71) Applicant: Samsung Electronics Co., Ltd., Gyeonggi-do (KR)

(72) Inventor: Mark G. Rison, Cambridge (GB)

(73) Assignee: Samsung Electronics Co., Ltd.

(21) Appl. No.: 14/522,053

(22) Filed: Oct. 23, 2014

(51) Int. Cl. H04L 5/00

(52) U.S. Cl. CPC H04L 5/0055

(57) ABSTRACT

A method for communication over a wireless network is provided. The method includes receiving, at a Station (STA), a frame over the wireless network; determining if the received frame is corrupted, and if the received frame is not corrupted, transmitting, on a first control response, to the peer STA information relating to the subsequent transmission of the peer STA, and if the received frame is corrupted, transmitting, on a second control response, to a peer STA information relating to a subsequent transmission of the peer STA.

### BACKGROUND OF THE INVENTION

1. Field of the Invention

The present invention relates generally to a method and apparatus for wireless communication, and more particularly, to a method and apparatus which allows legacy devices and next-generation devices to coexist with each other within next-generation networks and also within Overlapping Basic Service Sets (OBSS) of multiple networks, e.g., next-generation networks and legacy networks.

2. Description of the Related Art

The development of next-generation High Efficiency Wireless (HEW) communication networks, e.g., next-generation networks, and the devices, e.g., both Access Points (APs) and Stations (STAs), configured for use in such communication networks is on the rise. A primary focus when developing such communication networks is to increase an efficiency in which the next-generation networks can operate, such as in a situation where there are many devices, both APs and STAs, within range of each other but not necessarily all part of the next-generation network. That is, some of the APs and STAs can be next-generation devices, while others can be legacy devices that are operable over a legacy network, or a next-generation network, i.e. legacy STAs can use a next-generation AP (and legacy APs can support next-generation STAs).

However, the legacy devices, which may not have been developed with the next-generation technology in mind, may not work as well, if at all, in the next-generation communication networks. For example, as a result of the antiquated technology associated with the legacy devices, transmissions associated with the legacy devices, e.g., a legacy STA, may increase frame corruption within the next-generation networks and/or the legacy networks.

Unfortunately, known receiving devices, e.g., receiving Stations (STAs), that are operable over either the next-generation networks and the legacy networks are not capable of efficiently handling situations when a received frame is corrupted. That is, in such situations these receiving devices are unable to provide fast feedback to the AP (and also feedback from the AP to non-AP STAs) to allow the AP to adjust its Medium Access Control (MAC) and Physical (PHY) choices for the prevailing medium conditions over which the receiving devices and AP communicates, which, in turn, may decrease efficiency of the communication network, which, in turn, may result in degradation in a quality of experience provided to a user of the next-generation devices and/or legacy devices.

Therefore, there exists a need for a method and apparatus which allows legacy devices and next-generation devices to coexist with each other within next-generation networks and also within OBSS of multiple networks, e.g., next-generation networks and legacy networks.

### SUMMARY OF THE INVENTION

The present invention has been made to address the above problems and disadvantages, and to provide at least the advantages described below.

Accordingly, an aspect of the present invention is to provide a method and apparatus which allows legacy devices and next-generation devices to coexist with each other within next-generation networks and also within OBSS of multiple networks, e.g., next-generation networks and legacy networks.

Specifically, an aspect of the present invention allows a STA to provide information in control responses, such as Acknowledgements (Acks), to guide a peer STA's, e.g., an AP or another STA, future transmissions.

Therefore, in accordance with an aspect of the present invention, a method for communication over a wireless network is provided. The method includes receiving, at a STA, a frame over the wireless network; determining if the received frame is corrupted, and if the received frame is not corrupted, transmitting, on a first control response, to the peer STA information relating to the subsequent transmission of the peer STA, and if the received frame is corrupted, transmitting, on a second control response, to a peer STA information relating to a subsequent transmission of the peer STA.

In accordance with another aspect of the present invention, a method for communicating a frame among a plurality of STAs within a wireless network is provided. The method includes transmitting a frame from a first STA of the plurality of STAs; receiving, at a second STA, the frame over the wireless network; determining if the received frame is corrupted, and if the received frame is not corrupted, transmitting, on a first control response, to the first STA information relating to the subsequent transmission of the first STA, and if the received frame is corrupted, transmitting, on a second control response, to the first STA information relating to a subsequent transmission of the first STA.

In accordance with yet another aspect of the present invention, a STA is provided. The STA includes at least one processor configured to receive a frame over the wireless network, to determine if the received frame is corrupted, and if the received frame is not corrupted, to transmit, on a first control response, to the peer STA information relating to the subsequent transmission of the peer STA, and if the received frame is corrupted, to transmit, on a second control response, to a peer STA information relating to a subsequent transmission of the peer STA.

In accordance with another aspect of the present invention, a sniffer for communicating over a wireless network is provided. The sniffer includes at least one processor configured to detect a first control response, transmitted from a STA to a peer STA, including information relating to a subsequent transmission of the peer STA, and to detect a second control response, transmitted from the STA to the peer STA, including information relating to the subsequent transmission of the peer STA.

In accordance with still another aspect of the present invention, a non-transitory computer-readable medium having stored thereon a plurality of executable instructions, the plurality of instructions comprising instructions to transmit/receive, at a STA, a frame over the wireless network and to determine if the received frame is corrupted, and if the received frame is not corrupted, transmit, on a first control response, to the peer STA information relating to the subsequent transmission of the peer STA, and if the received frame is corrupted, transmit, on a second control response, to a peer STA information relating to a subsequent transmission of the peer STA.

### BRIEF DESCRIPTION OF THE DRAWINGS

The above and other aspects, features, and advantages of certain embodiments of the present invention will be more apparent from the following detailed description taken in conjunction with the accompanying drawings, in which:

FIG. 1 is a block diagram illustrating a wireless network, according to an embodiment of the present invention;

FIG. 2 is a block diagram illustrating components of the STAs shown in FIG. 1, according to an embodiment of the present invention;

FIG. 3 is a signaling diagram divided by a line for illustrating, in an upper half (A), a signaling sequence between two STAs that communicate over a wireless network according to an embodiment of the present invention and, in a lower half (B), a signaling sequence between two STAs that communicate over a wireless network according to another embodiment of the present invention;

FIG. 4 is a flowchart illustrating a method for communicating over a wireless network, according to an embodiment of the present invention; and

FIG. 5 is a flowchart illustrating a method for communicating a frame among a plurality of STAs within a wireless network, according to an embodiment of the present invention.

### DETAILED DESCRIPTION OF EMBODIMENTS OF THE PRESENT INVENTION

Various embodiments of the present invention will now be described in detail with reference to the accompanying drawings. In the following description, specific details such as detailed configuration and components are merely provided to assist in the overall understanding of the embodiments of the present invention. Therefore, it should be apparent to those skilled in the art that various changes and modifications of the embodiments described herein can be made without departing from the scope and spirit of the present invention. In addition, descriptions of well-known functions and constructions are omitted for clarity and conciseness.

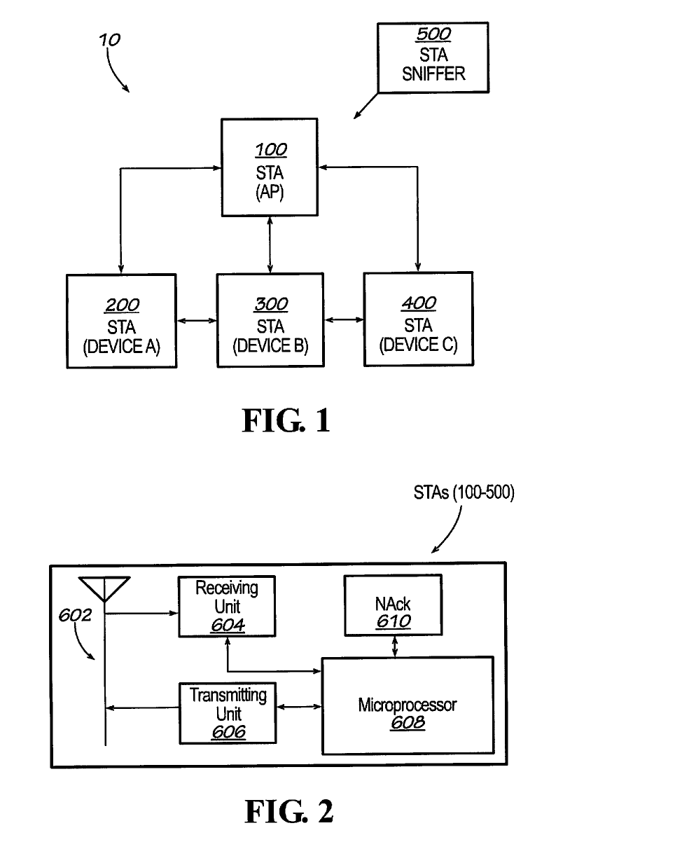

FIG. 1 illustrates a wireless communication network 10 (network 10), according to an embodiment of the present invention. The network 10 includes a plurality of STAs that are capable of communicating over the network 10. For illustrative purposes, the plurality of STAs is shown including a STA 100, e.g., an AP, and a plurality of associated user STAs 200, 300, 400, e.g., DEVICES A-C. The individual user STAs 200, 300, 400 may be embodied in the form of a cell phone, a Personal Digital Assistant (PDA), a laptop, a workstation, a personal computer, a video camcorder, etc. As can be appreciated, one or more of the user STAs 200, 300, and 400 can be embodied as another AP. Moreover, it is contemplated that the AP can also be component of a larger system or device, rather than being a dedicated AP.

One or more STAs 500 may be embodied in a form of a sniffer and may be implemented in the network 10, as will be described in more detail below.

While the AP 100 will be described herein as the transmitting device and the user STAs 200, 300, 400 as the receiving devices, it will be understood by those skilled in the art that both the AP 100 and user STAs 200, 300, 400 can each receive and transmit signals over the network 10.

Moreover, it should be appreciated that the user STAs 200, 300, 400 may be connected to other devices and/or networks with which these STAs may communicate. Further, though FIG. 1 only shows five stations within the network 10, it should be appreciated that the network 10 may include more than or fewer than five stations.

The network 10 can operate under one or more of the IEEE 802.11 standards such as the IEEE 802.11n, IEEE 802.11ax, IEEE 802.11ac, and IEEE 802.11a/b/g standards. However, other IEEE 802.11 standards are contemplated.

For illustrative purposes, the user STAs 200, 300 are described herein as next-generation devices, i.e., the STAs 200, 300 are configured for communicating over the IEEE 802.11ax wireless standard, and the user STA 400 is described herein as a legacy device, i.e., STA 400 is configured for communicating over the IEEE 802.11a/b/g/n/ac wireless standard.

The STA 100 is described herein as a next-generation device and is capable of communicating with other next-generation devices and legacy devices within the network 10. In other words, the STA 100 is capable of communicating with the user STAs 200, 300, 400 according to the IEEE 802.11ax wireless standard and the IEEE 802.11a/b/g/n/ac wireless standard.

FIG. 2 is a diagram illustrating an example of an embodiment of the components that may be provided in each of the STAs 100-400, 500 in the network 10. As shown in FIG. 2, each of the STAs 100-400, 500 is provided with antenna 602, a receiving unit 604, a transmitting unit 606, and at least one microprocessor (μp) 608. These components illustrated in FIG. 2 allow the STAs 100-400 to selectively transmit and receive frames within the network 10.

STA, 100, 200, and 300 may also include a Negative Ack (NAck) unit 610. The NAck unit 610 generates, recognizes, and transmits a control response, e.g., a NAck frame, upon reception of a corrupted frame that requires Ack, Block Ack, CTS, or any other acknowledgment. In addition, if a frame received at the STAs 100, 200, 300 is corrupted, the

NAck unit 610 is programmed to include information relating to a subsequent transmission of the transmitting STA, e.g., the STA 100 and/or other STAs within the network 10, in the control response, as will be described in more detail below.

Although the transmitting unit 606, the receiving unit 604, the μp 608, and the NAck unit 610 are depicted as separate entities in FIG. 2, persons of ordinary skill in the art should appreciate that the present invention is not so limited. For example, the μp 608 can be programmed to generate, recognize and transmit a NAck frame upon reception of a corrupted frame that requires Ack.

The μp 608 controls the overall operation of the STAs 100-400, 500. In addition, if a frame received at the STAs 100, 200, 300, 500 is not corrupted, the μp 608 is programmed to generate a control response, e.g., an Ack frame, which includes information relating to a subsequent transmission of the transmitting STA, e.g., the STA 100 and/or other STAs within the network 10, as will be described in more detail below.

The receiving unit 604 receives modulated frames over the network 10 and provides the modulated messages to the μp 608 for decoding.

The transmitting unit 606 of the STAs 100-400, 500 transmits one or more modulated frames provided by the μp 608 over the network 10, according to one or more transmitting protocols. For example, the STAs 100-400, 500 transmit frames including, but not limited to, control frames, data frames, etc, all of which may be provided in the Physical (PHY) layer.

Moreover, the transmitting unit 606 transmits frames in accordance with special priority requirements, e.g., after a pre-defined idle period following a preceding frame transmission. This pre-defined idle period is equal to a Distributed Coordination Function (DCF) Inter Frame Space time interval (DIPS) or an Enhanced Distributed Channel Access Function (EDCAF) Arbitration

IFS (AIFS); the IFS is equal to the time interval between frames and the DIFS allows for compliancy with legacy devices/networks. The different IFS time intervals are defined in the IEEE 802.11 standard as time gaps on the radio medium and are fixed. One such gap is the above mentioned DIFS time interval and three others are the Extended IFS (EIFS) time interval, the Reduced IFS (RIFS) time interval, and the Short IFS (SIFS) time interval.

The SIFS time interval is used for the highest-priority transmissions. Once these high-priority transmissions begin, the network 10 becomes busy, so frames transmitted after the SIFS interval has elapsed have priority over lower-priority frames that can be transmitted only after longer intervals, such as a Point Coordination Function IFS (PIFS) time interval and the DIFS time interval described above.

The EIFS time intervals are used to allow ongoing transmissions to continue and end successfully even though another station (that back-offs for the duration of EIFS time interval) has not received the transmission, e.g. it could not decode the message. In the IEEE 802.11 standard the EIFS time interval are used by the DCF or the EDCAF whenever the PHY has indicated to the Medium Access Control (MAC) that a frame transmission did not result in the correct reception of a complete MAC frame with a correct Frame Check Sequence (FCS) values. The EIFS time interval begins following indication by the PHY that the medium is idle after detection of the erroneous frame, e.g., a corrupted frame has been generated, as a result of a legacy device transmitting within a next-generation network.

In accordance with embodiments of the present invention, the STAs 100-300 are configured to determine if a received frame is corrupted. Indicators that may be used to make such a determination may include, but are not limited to at least one of a protocol version, type, and subtype of the received frame; whether To/From Differentiated Service (DS) bits match one of a BSS type and a role of a known peer STA; whether Address 1 of the received frame is the STA's address (in the IEEE 802.11 standard, Address 1 is the receiver address); whether Address 2 of the received frame is a known peer STA's address (in the IEEE 802.11 standard, Address 2 is the transmitter address), whether a Physical (PHY) header of the received frame signals an Aggregate-Medium Access Control Protocol Data Unit (A-MPDU); whether all MPDUs in an High Throughput A-MPDU (HT A-MPDU) of the received frame are corrupt; whether an MPDU of the received frame signals a Very HT (VHT) single MPDU; and whether all MPDUs of the received frame in a non-single VHT A-MPDU are corrupt. As can be appreciated, other methods can also be used by the STA that received the corrupted frame to verify that the received, corrupted frame was with high probability one which was addressed to that particular STA and which expected acknowledgement.

In accordance with the present invention, after a frame is successfully received at the STAs 100-300, the STAs 100-300 are configured to transmit, on one or more control responses, such as an Ack frame, a BlockAck frame, a Clear-To-Send (CTS) frame, and/or data/management frames (e.g., control-like management frames such as time priority management frames), information relating to the received frame to the transmitting STA (or peer STA) for guiding subsequent transmissions of the transmitting STA. e.g., the STA 100.

For example, according to embodiments of the present invention, if the STA 100 (i.e., data originator) transmits a frame to the STAs 200, 300, and it is determined at the STAs 200, 300 that the received frame is one that is not corrupted but, for example, included low Signal-To-Noise (SNR) ratio and required acknowledgement, the μp 608 of the STAs 200, 300 is configured to transmit a first control response, e.g., an Ack frame, to the STA 100 indicating that, while the received frame was not corrupted, the received frame included low SNR and that the STA 100 should transmit the next frame, e.g., after a SIFS time interval, with safer parameters thereby allowing for very fast adaptation of the first control response. As can be appreciated, the first control response can also be embodied in the BlockAck frame, the CTS frame, and/or the data/management frames. Moreover, instead of transmitting the first control response after the SIFS time interval, the μp 608 can also be configured to transmit the first control response after or before the other aforementioned IFS time intervals or other IFS time interval, e.g., an AIFS time interval.

According to another embodiment of the present invention, if the STA 100 (i.e., data originator) transmits a frame to the STAs 200, 300, and it is determined at the STAs 200, 300 that the received frame is corrupted but requires acknowledgement, the NAck unit 610 of the STAs 200, 300 is configured to transmit a second control response, e.g., a NAck frame, to the STA 100 indicating that the received frame is corrupted and that the STA 100 should retransmit the frame. The second control response can be transmitted after or before any of the IFS time intervals described above relating to the first control response.

In the accordance with the embodiments of the present invention, the information that the first control response and the second control response, which are used to guide the STA 100 (or other receiving STA), can include, but is not limited, to information relating to one of a SNR of the received frame; a Received Channel Power indicator (RCPI) of the received frame; an Error Vector Magnitude (EVM) of the received frame; an extent of corruption of the received frame; a nature of interference of the received frame, including burst interference, continuous interference, periodic interference, and non-802.11 interference; an OBSS of the network in which the frame is transmitted; a Modulation and Coded Scheme (MCS) of the next transmitted frame; a Number of Spatial Streams (NSS) of the next transmitted frame; and a bandwidth of the next transmitted frame.

In accordance with the embodiments of the present invention, if the information transmitted on the first control response and second control response relates to a SNR, a RCPI, and an EVM of the received frame, then the STA 100 is configured to adjust one of a transmit (tx) power and MCS of the subsequent frame that is to be transmitted from the STA 100 to the STAs 200, 300. It is noted that adjusting the transmit (tx) power and MCS of the subsequent frame are just two of the countless parameters that may be adjusted by the STA 100 in response to the information that is fed back on the first control response and second control response.

Moreover, if the information transmitted on the first control response and second control response relates to an extent of corruption of the received frame, then the STA 100 is configured to one of reduce a MCS and change aggregation/fragmentation of the subsequent frame that is to be transmitted from the STA 100 to the STAs 200, 300.

Further, if the information transmitted on the first control response and the second control response relates to a nature of interference of the received frame, including burst interference, continuous interference, periodic interference, then the STA 100 is configured to determine whether reducing the MCS of the subsequent frame or using a Request-To-Send (RTS)/CTS for the subsequent frame that is to be transmitted from the STA 100 to the STAs 200, 300 would be advantageous and to determine whether to change aggregation/fragmentation of the subsequent frame that is to be transmitted from the STA 100 to the STAs 200, 300.

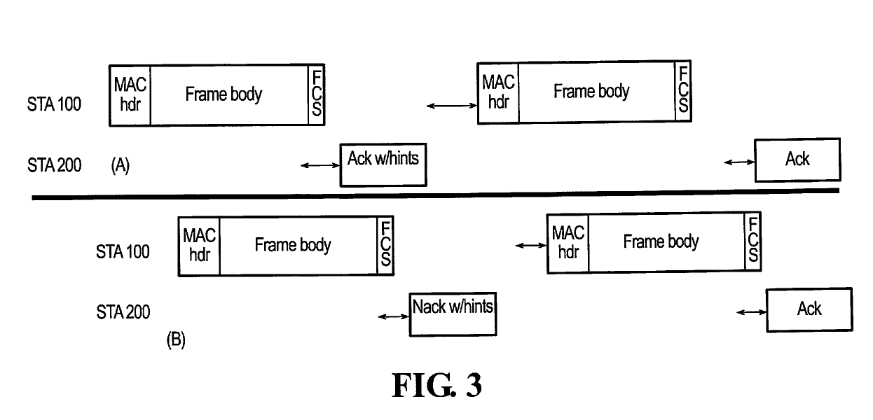

FIG. 3 is a signaling diagram divided by a line for illustrating, in an upper half (A), a signaling sequence between two STAs that communicate over a wireless network according to an embodiment of the present invention and, in a lower half (B), a signaling sequence between two STAs that communicate over a wireless network according to another embodiment of the present invention. For illustrative purposes, the two STAs are assumed to be STA 100 and STA 200.

Referring to the upper half (A) of FIG. 3, STA 100 transmits to STA 200 a frame, which is successfully received and one which requires Ack, e.g., prior to the expiry of AckTime-out. If it is determined by the μp 608 of the STA 200 that the SNR of the received frame is low and that there is continuous interference, then the μp 608 generates the first control response, e.g., Ack frame, and transmits the first control response including the SNR and interference information to the STA 100.

In response to the STA 100 receiving the Ack frame from the STA 200, the μp 608 of the STA 100 generates the subsequent frame including, for example, a lower MCS, as compared to the MCS of the original frame that was transmitted to the STA 200, making it more likely that the subsequent frame will be successfully received despite the continuous interference. In accordance with the embodiments of the present invention, the μp 608 of the STA 100 can transmit the subsequent frame to the STA 200 after one of the aforementioned IFS time intervals, such as after the SIFS time interval and/or the AIFS time interval, thereby minimizing medium time.

Referring to the lower half (B) of FIG. 3, STA 100 transmits to STA 200 a frame, which is corrupted. The NAck unit 610 determines that the received, corrupted frame requires Ack, e.g., prior to the expiry of AckTime-out, using one of the aforementioned methods described above, such as determining at least one of a protocol version, type, and subtype of the received frame. Accordingly, the μp 608 generates the second control response, e.g., NAck frame, and transmits the second control response to the STA 100. In addition, the NAck unit 610 includes on the NAck frame information relating to, for example, a SNR of the received frame, e.g., the SNR is high but there is severe concentrated corruption caused by a long-period non-802.11 interferer or legacy device, e.g., STA 400, which is not shown in FIG. 3.

In response to the STA 100 receiving the NAck frame from the STA 200, the NAck unit 610 (or μp 608) generates a subsequent frame, which is a reproduction of the original frame that was transmitted to the STA 200, while keeping the MCS high, thereby minimizing the time the subsequent frame occupies the medium and making it more likely that the subsequent frame will be successfully received without severe concentrated corruption, i.e., the less time the subsequent frame occupies the medium the less likely that it will become corrupted. In accordance with the embodiments of the present invention, the NAck unit 610 (or μp 608) can transmit the subsequent frame to the STA 200 after one of the aforementioned IFS time intervals, such as after the SIFS time interval and/or the AIFS time interval, thereby minimizing medium time.

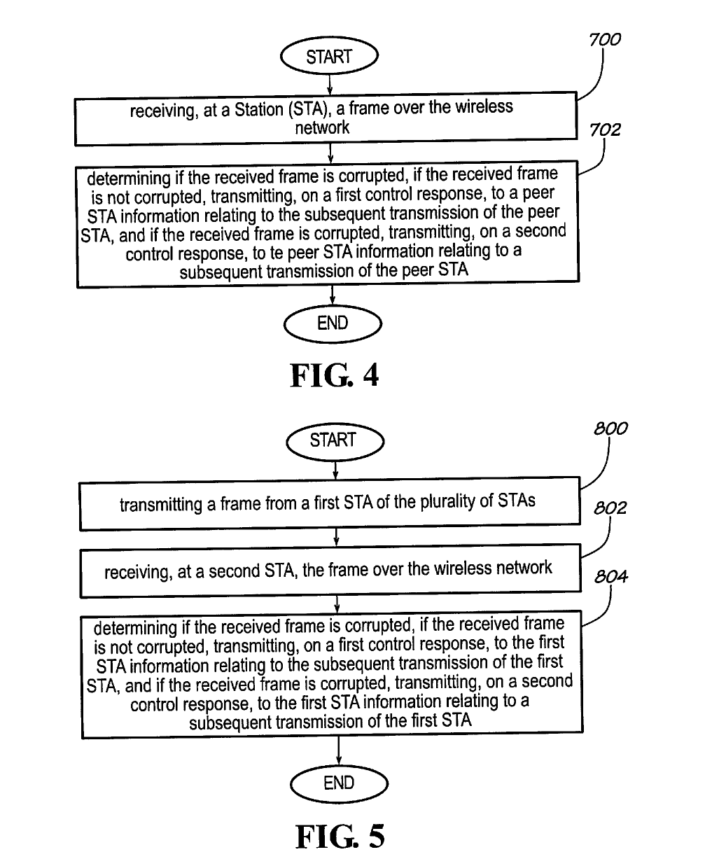

FIG. 4 is a flowchart illustrating a method for communicating over a wireless network, according to an embodiment of the present invention.

Referring to FIG. 4, a frame is received at STA 200 over the network 10, at step 700. The μp 608 and/or the NAck unit 610 of the STA 200 determines, at step 702, if the received frame is corrupted, and if the received frame is not corrupted, the .μp 608 transmits, on the first control response, to the STA 200 information relating to the subsequent transmission of the STA 100, and if the received frame is corrupted, the NAck unit 610 transmits, on the second control response, to the STA 200 information relating to a subsequent transmission of the STA 100.

FIG. 5 is a flowchart illustrating a method for communicating a frame between a plurality of STAs within a wireless network, according to an embodiment of the present invention.

Referring to FIG. 5, a frame is transmitted by the μp 608 of the STA 100, at step 800, and is received at the STA 200, at step 802. The μp 608 and/or the NAck unit 610 of the STA 200 determines, at step 804, if the received frame is corrupted, and if the received frame is not corrupted, the μp 608 transmits, on the first control response, to the STA 200 information relating to the subsequent transmission of the STA 100, and if the received frame is corrupted, the NAck unit 610 transmits, on the second control response, to the STA 200 information relating to a subsequent transmission of the STA 100.

In accordance with the embodiments of the present invention, the STAs 100-300 described herein are capable of transmitting the first control response and second control response, which allows for a wide range of information to be communicated between STAs 100-300 within the network 10, as opposed to conventional STAs that do not have feedback from other STAs and, therefore, have difficulty determining which one of the MCSes to use. Having such capabilities allows the STA 100 to be guided by the STAs 200, 300, rather than having to accept or reject a direct peer recommendation as in conventional STAs (cf. the MCS feedback features of 802.11n/ac), which, in turn, may minimize the effects of the various impairment scenarios that may be present within network 10, e.g., corrupted frames, low SNR, etc.

For example, regarding received, corrupted frames (i.e. a received frame required acknowledgment but was partially corrupted, e.g. SNR barely above the required minimum or a large EVM), the STAs 200, 300 are capable of: determining if the received, corrupted frame was addressed to the STAs 200, 300; determining if the received, corrupted frame required Ack; and generating and transmitting a NAck frame including additional information to the STA 100 during the SIFS time interval. This, in turn, may increase the efficiency of the network 10 as compared to conventional networks, as conventional networks are configured to wait for the expiry of the AckTime-out, which is typically much longer than the SIFS time interval.

In accordance with embodiments of the present invention, it may prove advantageous to provide the STA 400, i.e., a legacy device, with a capability of indicating their compatibility with the first control response and second control response according to the embodiments of the present invention, since any modification to (e.g., lengthening of) conventional control response frames may not be compatible with legacy devices. For example, an Ack frame that contains anything other than frame control information, frame duration information, a receiver address (RA), i.e., Address 1, of the intended receiver STA, and/or FCS information, may not be compatible with the legacy devices. Accordingly, such legacy devices may be configured to use, for example, a capabilities bit or other signalling function exchanged when the legacy devices join the network 10, to indicate the legacy device's ability to handle such first and second control responses; this may be a specific bit such as “enhanced frames” bit or a more general bit such as “High-Efficiency Wireless” bit that may be provided on the first and second control responses.

As noted above, the network 10 may also include a STA 500 that is embodied in the form of a sniffer (FIG. 1). The STA 500, or packet analyzer, can be used in the network 10 to intercept and log traffic passing over the network 10. The STA 500 may be implemented in hardware or software. As data streams flow across the network 10, the STA 500 can be configured to capture data and, if needed, decode and analyze their content or provide the captured data to an analyzing tool for further processing. The captured data may for instance be analyzed to obtain information about the network 10 or the communication, e.g. to debug the communication or to diagnose problems of the network 10.

Accordingly, in accordance with another embodiment of the present invention, the STA 500 is embodied in the form of a sniffer for communicating over a wireless medium and includes the μp 608 and/or the NAck unit 610 which are configured to detect a first control response, transmitted from STAs 200, 300 to the STA 100, including information relating to a subsequent transmission of STA 100, and to detect a second control response, transmitted from the STAs 200, 300 to the STA 100, including information relating to the subsequent transmission of the peer STA.

The present invention or aspects thereof are capable of being distributed in the form of a non-transitory computer-readable program product stored in a tangible computer medium having stored thereon a plurality of executable instructions. The plurality of executable instructions may be in a variety of forms for execution on a processor, processors, or the like, and the present invention applies equally regardless of the particular type of signal-bearing media used to actually carry out the distribution.

The plurality of instructions comprise instructions to transmit/receive, at a STA, e.g., STAs 100-400, a frame over the wireless network and determine if the received frame is corrupted, if the received frame is not corrupted, transmit, on a first control response, to the peer STA, e.g., STA 100, information relating to the subsequent transmission of the peer STA, and if the received frame is corrupted, transmit, on a second control response, to a peer STA information relating to a subsequent transmission of the peer STA.

The non-transitory computer readable program product can be in the form of microcode, programs, routines, and symbolic languages that provide a specific set or sets of ordered operations that control the functioning of the hardware and direct its operation, as known and understood by those skilled in the art. Examples of computer readable media include, but are not limited to: nonvolatile hard-coded type media such as read only memories (ROMs), CD-ROMs, and DVD-ROMs, or erasable, electrically programmable read only memories (EEPROMs), recordable type media such as floppy disks, hard disk drives, CD-R/RWs, DVD-RAMs. DVD-R/RWs, DVD+R/RWs, flash drives, memory sticks, HD-DVDs, mini disks, laser disks, Blu-ray disks, and other newer types of memories, and transmission type media such as digital and analog communication links.

In accordance with the embodiments of the present invention, the non-transitory computer readable program product can be installed on the STA 400 so that the STA 400 can perform the aforementioned operations that were described herein with respect to the STAs 100-300 and 500.

While the above embodiments have described herein as using a NAck frame for indicating to the STA 100 that the received frame was corrupted, other frames may also be used. For example, the Ack frame can be modified or enhanced to indicate to the STA 100 that the received frame was corrupted.

While the present invention has been particularly shown and described with reference to certain embodiments thereof, it will be understood by those of ordinary skill in the art that various changes in form and details may be made therein without departing from the spirit and scope of the present invention as defined by the following claims and their equivalents.

What is claimed is:

1. A method for communicating over a wireless network, the method comprising:
receiving, at a Station (STA), a frame over the wireless network;
determining if the received frame is corrupted, and if the received frame is not corrupted, transmitting, on a first control response, to the peer STA information relating to the subsequent transmission of the peer STA, and if the received frame is corrupted, transmitting, on a second control response, to a peer STA information relating to a subsequent transmission of the peer STA.

2. The method according to claim 1, wherein the first control response is one of an Ack frame, a BlockAck frame, a Clear-To-Send (CTS) frame and a data/management frame.

3. The method according to claim 1, wherein the second control response is a Negative Acknowledgement (NAck) frame.

4. The method according to claim 1, further comprising, after receiving at the peer STA one of the first control response and second control response, transmitting, by the peer STA, a subsequent frame that is generated based on the information transmitted on one of the first control response and second control response.

5. The method according to claim 1, wherein the subsequent frame is transmitted during one of a Short InterFrame Space (SIFS) time interval, a Distributed coordination function IFS (DIFS) time interval, a Point coordination function IFS (PIFS) time interval, an Extended IFS (EIFS) time interval, Reduced IFS time intervals (RIFS), and an Arbitration IFS (AIFS) time interval.

6. The method according to claim 1, wherein the information transmitted on one of the first control response and second control response comprises information relating to one of: a Signal to Noise Ratio (SNR) of the received frame; a Received Channel Power indicator (RCPI) of the received frame; an Error Vector Magnitude (EVM) of the received frame; an extent of corruption of the received frame; a nature of interference of the received frame, including burst interference, continuous interference, periodic interference, non-IEEE 802.11 interference; an Overlapping Basic Service Sets (OBSS) of the network in which the frame is transmitted; a Modulation and Coded Scheme (MCS) of the next transmitted frame; a Number of Spatial Streams (NSS) of the next transmitted frame; and a bandwidth of the next transmitted frame.

7. The method according to claim 6, wherein if the information transmitted on the one of the first control response and second control response relates to one of a SNR, an RCPI, and an EVM of the received frame, then the peer STA is configured to adjust one of a transmit (tx) power and a MCS of the subsequent frame that is to be transmitted from the peer STA.

8. The method according to claim 6, wherein if the information transmitted on the one of the first control response and second control response relates to an extent of corruption of the received frame, then the peer STA is configured to one of reduce a MCS and change aggregation/fragmentation of the subsequent frame that is to be transmitted from the peer STA.

9. The method according to claim 6, wherein if the information transmitted on the one of the first control response and second control response relates to a nature of interference including burst interference, continuous interference, periodic interference, then the peer STA is configured to determine whether reducing a MCS of the subsequent frame or using a Request-To-Send (RTS)/CTS for the subsequent frame that is to be transmitted from the peer STA would be advantageous and to determine whether to change aggregation/fragmentation of the subsequent frame that is to be transmitted from the peer STA.

10. A method for communicating a frame among a plurality of Stations (STAs) within a wireless network, the method comprising:
transmitting a frame from a first STA of the plurality of STAs;
receiving, at a second STA, the frame over the wireless network;
determining if the received frame is corrupted, and if the received frame is not corrupted, transmitting, on a first control response, to the first STA information relating to the subsequent transmission of the first STA, and if the received frame is corrupted, transmitting, on a second control response, to the first STA information relating to a subsequent transmission of the first STA.

11. The method according to claim 10, wherein the first control response is one of an Ack frame, a BlockAck frame, a Clear-To-Send (CTS) frame and a data/management frame.

12. The method according to claim 10, wherein the second control response is a Negative Acknowledgement (NAck) frame.

13. The method according to claim 10, further comprising, after receiving at the first STA one of the first control response and second control response, transmitting, by the first STA, a subsequent frame that is generated based on the information transmitted on one of the first control response and second control response.

14. The method according to claim 10, wherein the subsequent frame is transmitted during one of a Short InterFrame Space (SIFS) time interval, a Distributed coordination function IFS (DIFS) time interval, a Point coordination function IFS (PIFS) time interval, an Extended IFS (EIFS) time interval, Reduced IFS time intervals (RIFS), and an Arbitration IFS (AIFS) time interval.

15. The method according to claim 10, wherein the information transmitted on one of the first control response and second control response comprises information relating to one of: a Signal to Noise Ratio (SNR) of the received frame; a Received Channel Power indicator (RCPI) of the received frame; an Error Vector Magnitude (EVM) of the received frame; an extent of corruption of the received frame; a nature of interference of the received frame, including burst interference, continuous interference, periodic interference, non-IEEE 802.11 interference; an Overlapping Basic Service Sets (OBSS) of the network in which the frame is transmitted; a Modulation and Coded Scheme (MCS) of the next transmitted frame; a Number of Spatial Streams (NSS) of the next transmitted frame; and a bandwidth of the received frame of the next transmitted frame.

16. The method according to claim 15, wherein if the information transmitted on the one of the first control response and second control response relates to one of a SNR, an RCPI, and an EVM of the received frame, then the peer STA is configured to adjust one of a transmit (tx) power and a MCS of the subsequent frame that is to be transmitted from the peer STA.

17. The method according to claim 15, wherein if the information transmitted on the one of the first control response and second control response relates to an extent of corruption of the received frame, then the first STA is configured to one of reduce MCS and change aggregation/fragmentation of the subsequent frame that is to be transmitted from the first STA.

18. The method according to claim 15, wherein if the information transmitted on the one of the first control response and second control response relates to a nature of interference including burst interference, continuous interference, periodic interference, then the first STA is configured to determine whether reducing a MCS of the subsequent frame or using a Request-To-Send (RTS)/CTS for the subsequent frame that is to be transmitted from the first STA would be advantageous and to determine whether to change aggregation/fragmentation of the subsequent frame that is to be transmitted from the first STA.

19. A Station (STA) comprising:
at least one processor configured to receive a frame over the wireless network, to determine if the received frame is corrupted, and if the received frame is not corrupted, to transmit, on a first control response, to the peer STA information relating to the subsequent transmission of the peer STA, and if the received frame is corrupted, to transmit, on a second control response, to a peer STA information relating to a subsequent transmission of the peer STA.

20. The STA according to claim 19, wherein the first control response is one of an Ack frame, a BlockAck frame, a Clear-To-Send (CTS) frame and a data/management frame.

21. The STA according to claim 19, wherein the second control response is a Negative Acknowledgement (NAck) frame.

22. The STA according to claim 19, wherein the subsequent frame is transmitted during one of a Short InterFrame Space (SIFS) time interval, a Distributed coordination function IFS (DIFS) time interval, a Point coordination function IFS (PIFS) time interval, an Extended IFS (EIFS) time interval, Reduced IFS time intervals (RIFS), and an Arbitration IFS (AIFS) time interval.

23. The STA according to claim 19, wherein the information transmitted on one of the first control response and second control response comprises information relating to one of: a Signal to Noise Ratio (SNR) of the received frame; a Received Channel Power indicator (RCPI) of the received frame; an Error Vector Magnitude (EVM) of the received frame; an extent of corruption of the received frame; a nature of interference of the received frame, including burst interference, continuous interference, periodic interference, non-IEEE 802.11 interference; an Overlapping Basic Service Sets (OBSS) of the network in which the frame is transmitted; a Modulation and Coded Scheme (MCS) of the next transmitted frame; a Number of Spatial Streams (NSS) of the next transmitted frame; and a bandwidth of the next transmitted frame.

24. A sniffer for communicating over a wireless network, the sniffer comprising:
at least one processor configured to detect a first control response, transmitted from a STA to a peer STA, including information relating to a subsequent transmission of the peer STA, and to detect a second control response, transmitted from the STA to the peer STA, including information relating to the subsequent transmission of the peer STA.

25. A non-transitory computer-readable medium having stored thereon a plurality of executable instructions, the plurality of instructions comprising instructions to:
transmit/receive, at a Station (STA), a frame over the wireless network; and
determine if the received frame is corrupted, and if the received frame is not corrupted, transmit, on a first control response, to the peer STA information relating to the subsequent transmission of the peer STA, and if the received frame is corrupted, transmit, on a second control response, to a peer STA information relating to a subsequent transmission of the peer STA.
